(19) United States
(12) Patent Application Publication
(10) Pub. No.: US 2014/0181667 A1
(43) Pub. Date: Jun. 26, 2014

(54) Metadata Assisted Trick Mode Intervention Method And System

(71) Applicants: Jianfeng Chen, Beijing (CN); Xianjun Ma, Beijing (CN)

(72) Inventors: Jianfeng Chen, Beijing (CN); Xianjun Ma, Beijing (CN)

(73) Assignee: Thomson Licensing, Issy de Moulineaux (FR)

(21) Appl. No.: 14/234,666

(22) PCT Filed: Jul. 25, 2011
(86) PCT No.: PCT/CN2011/077565

§ 371 Date: Jan. 24, 2014

(51) Int. Cl. G06F 3/0484

(52) U.S. Cl. CPC G06F 3/0484
USPC 715/716

(57) ABSTRACT

A method and apparatus are described including accepting metadata, identifying segments of multimedia content that are for viewing, storing the identified segments of multimedia content, detecting trick mode playback initiation, determining if a starting point of the trick mode playback is prior to a next identified segment, determining a play-out time for the metadata if the first determination is positive, determining a corresponding time to start play-out of the metadata, playing back the metadata starting immediately if the first determination is negative or at the determined corresponding time, displaying a dialog box with a query, accepting input from a user in response to the query, playing back of one of the stored identified segments of multimedia content responsive to the accepted input at a normal mode speed and reverting to trick mode playback upon completion of the playing back of the one of the stored identified segment of multimedia content.

### FIELD OF THE INVENTION

The present invention relates to a media system for trick mode intervention with metadata indication. Additional content will be displayed during trick mode operation to emphasize segment recommendations from, for example, the media creator point of view or previous audience members.

### BACKGROUND OF THE INVENTION

Multimedia playing is a very popular service in any multimedia enabled devices. Either hardware players such as a DVD player, an MP4 player or software players such as Windows media player by Microsoft and QuickTime player by Apple provide playback control for the end user. The typical operations include “Open”, “Play”, “Pause”, “Stop”, “Fast Forward”, “Rewind” etc., in which “Fast Forward” and “Rewind” enable speed control options for end users to quickly seek the position they want to playback. Content playback during these actions is often referred to as “trick mode” playback. Content includes but is not limited to audio, video, multimedia, text and data. The use of the term content and any of these forms of content (e.g., video) are interchangeable and no limitation is expressed or implied. In the implementation of a conventional content player, when “Fast Forward” or “Rewind” is selected by the end user, the video sequence will be played at a faster speed (e.g. 2×, 4×, 8×) than the normal playback speed. Thus, some frames will be skipped and the movement and scene of the video will appear to be a fast motion change to the viewer (user). From the human visual point of view, although it is still somehow understandable for some of the scene changes using trick mode, the display of the video frames is not content-aware. Some of the key frames or sub segments will be inadvertently skipped, for example, an explosion scene in an action movie with a 360 degree view may last only 10 seconds at the normal playback speed. In the “Fast Forward” mode, it will be displayed as only one frame and, thus, cannot reflect its actual effect. In another example, the director may insert a short clip of a childhood memory of the key character. This short clip may give a viewer valuable insight into both the character and the story. However, the short clip may not be displayed or displayed as only one or two frames in trick mode, but this content is very important to the experience of the whole movie (video).

US Patent Application Serial Number 2010/0077435 entitled “System and Method for Smart Trick Mode Display” proposed a method to select frames to display during trick mode depending on the interest, likes or dislikes of an end user. In the application, the major consideration is to emphasize the selected relevant key frames of interest or automatically skip some sub-segment that the user might not wish to see. However, the user's interests are very general in nature, for example, sports, love stories, history, famous building etc. Even for a similar scene, the composition of the picture and the story telling may be different according to the different movie directors and the movie types, and its affect on the movie as a whole will vary greatly. Therefore, in the present invention, the recommendations of the source owner such as movie director, video creator or TV director, which may prove more valuable and specific for given content, are considered. In the present invention, the background introduction and the idea explanation, which may also help an end user to identify key frames and important sub-segments to view, are also considered. Another advantage of the present invention is the introduction of the additional media playback to emphasize the importance of the skipped frame or sub-segment on the main display device or a second auxiliary display device. Another difference between the above identified patent application and the method of the present invention is that there is no user behavior monitoring required in the method of the present invention.

### SUMMARY OF THE INVENTION

The present invention resolves the inadvertent skipping or missing of key frames and sub-segments under trick mode operation (such as “Fast Forward” and “Rewind”) when multimedia content is playing. The recommendation from the director or creator of the multimedia content is inserted in the metadata information accompanying the multimedia content. During trick mode operation, an additional dialog box will be displayed, the purpose of which is to emphasize the importance of the potentially skipped or missed portion of content and suggest to an end user to view it in another way (normal playback). Therefore, the key frames or sub-segments of the multimedia content can be retained for delivery and review by the end user even under the trick mode operation. This will occur if the end user elects retention of a key segment. In this event, trick mode operation will revert to normal playback operation for the duration of the key segment and then return to trick mode operation after playing of the key segment at normal speed has completed.

The present invention provides a method for providing recommendation information determined by the director or creator in metadata inserted into the multimedia content. During trick mode “Fast Forward” or “Rewind” operation in a given multimedia playback if the corresponding recommended (key) segment, as determined by the content owner and indicated in the metadata, would be skipped, then a dialog box will be displayed to suggest (remind) the end user to view the recommended (key) segment at normal playback speed (operation). The additional dialog box interruption only occurs during trick mode operation and has no affect on normal playback speed or operation. No user input or behavior is required to invoke this function.

A method and apparatus are described including accepting metadata, identifying segments of multimedia content that are recommended for viewing, storing the identified segments of multimedia content, detecting trick mode playback initiation, determining if a starting point of the trick mode playback is prior to a next identified segment, determining a play-out time for the metadata if the first determination is positive, determining a corresponding time to start play-out of the metadata, playing back the metadata starting immediately if the first determination is negative or at the determined corresponding time, displaying a dialog box with a query, accepting input from a user in response to the query, playing back of one of the stored identified segments of multimedia content responsive to the accepted input at a normal mode speed and reverting to trick mode playback upon completion of the playing back of the one of the stored identified segment of multimedia content.

### BRIEF DESCRIPTION OF THE DRAWINGS

The present invention is best understood from the following detailed description when read in conjunction with the accompanying drawings. The drawings include the following figures briefly described below:

FIG. 1 is a block diagram of an exemplary embodiment of the trick mode intervention system of the present invention.

FIG. 2 is an exemplary multimedia playback sequence for media content and additional content (metadata) during “Fast Forward” trick mode operation in accordance with principles of the present invention.

FIGS. 3A and 3B together are a flowchart of the operation an embodiment of the trick mode intervention system of the present invention.

### DETAILED DESCRIPTION OF THE PREFERRED EMBODIMENTS

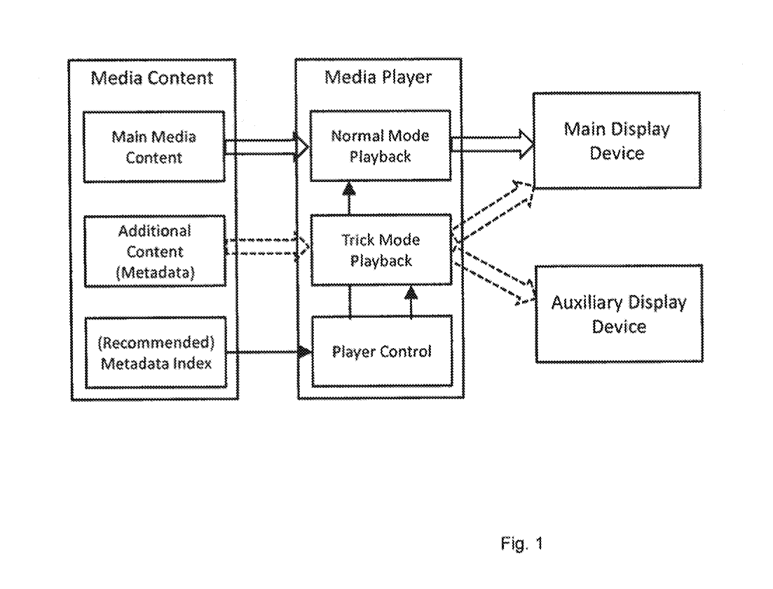

FIG. 1 is a block diagram of an exemplary embodiment of the trick mode intervention system of the present invention. The exemplary embodiment of the trick mode intervention system depicted in FIG. 1 includes three main components—the media content, the media player portion and device display portions. Media content includes the main content (e.g., the movie, video, etc.), additional content (metadata) with recommendations by the content owner or content creator regarding key (important) scenes, segments, frames or sub-segments, and an index of the metadata recommending certain scenes (frames, segments, sub-segments) as key or important. The media content and metadata format may vary depending on the particular implementation, such as video format of MPEG2/MPEG4/MOV/RM or rich media format Flash/SWF etc. In one embodiment, if the media content is provided according to a standard allowing metadata insertion such as MP4 file format (ISO/IEC14496), the recommendation metadata is provided in connection with the media content according to that standard. For example, ‘meta box’ is the common base structure used to format general metadata. A ‘meta box’ contains descriptive or annotative metadata. The ‘meta’ box is required to contain a ‘hdlr’ box indicating the structure or format of the ‘meta’ box contents. That metadata is located either within a box within this box, or is located by the item identified by a primary item box. One example of the recommended metadata items is shown in Table 1 below.

TABLE 1

| | | | Type | |
|---|---|---|---|---|
| Time Interval | Sequence | Recommended | (audio/ | Duration |
| (h:m:s) | Number | Program (ID) | video) | (second) |
| 00:01:01-00:01:35 | 1 | R001 | audio | 10 |
| 00:03:01-00:04:25 | 2 | R002 | video | 30 |
| . . . | . . . | . . . | . . . | . . . |

The fields can be explained as follows:
Time Interval: The starting point R₁^{s} and ending point R₁^{e} of the recommended (suggested) segment (scene, frames, sub-segment, fragment) of content that was determined by the director or source creator. This part of media content that has been determined by the content owner or content creator to be key or important is important for the media presentation as a whole.
Sequence Number: The sequence of the recommended segment (scene, frames, sub-segment, fragment) of content.
Recommended Program ID: The Recommended Program ID gives an end user an indication of the reason that the segment (fragment, scene, sub-segment, frame(s)) is important and the value of the recommended segement. The additional media can be an interview of the director, comments from the audience, documentary of the main content creation etc.
Type: The media type of the additional media, e.g., audio, video, data, etc.
Duration: The duration of the additional media item. The duration is the playback time required for playing back this media content in normal operation (speed).

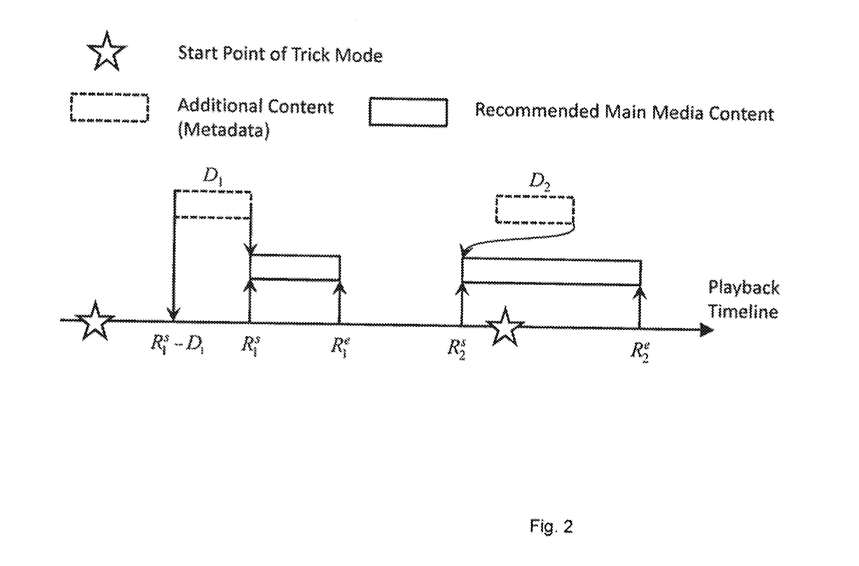

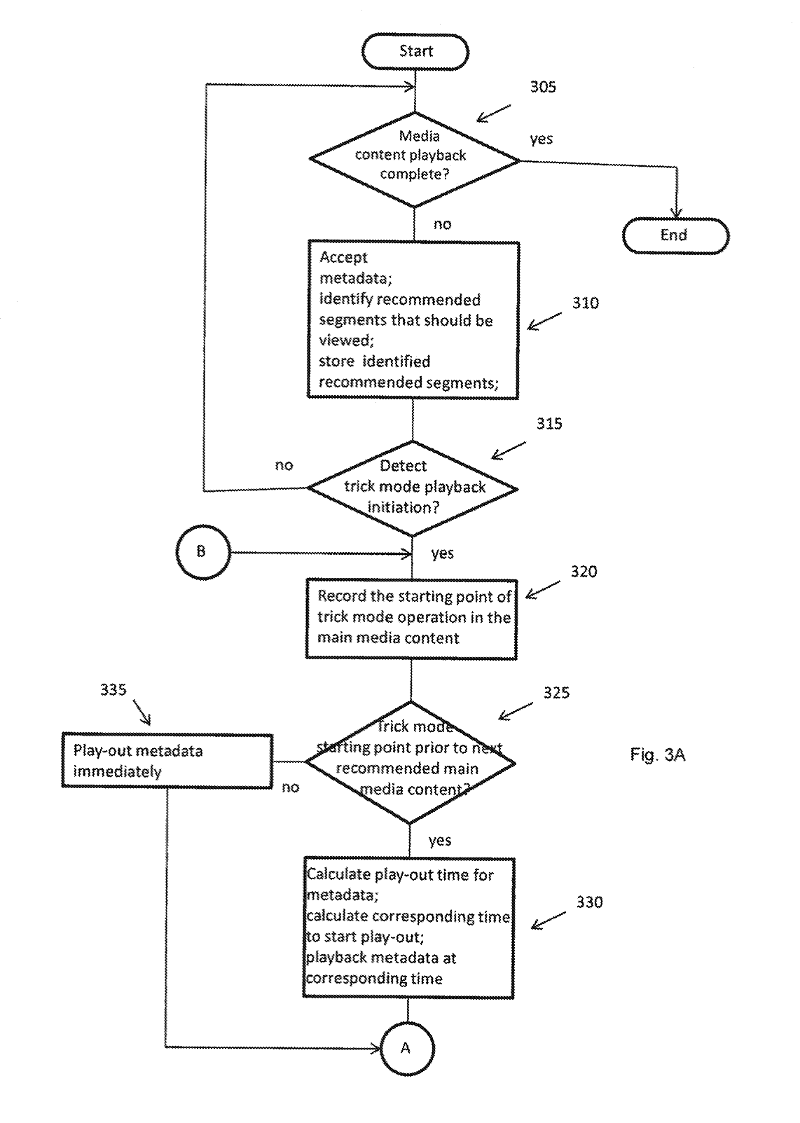

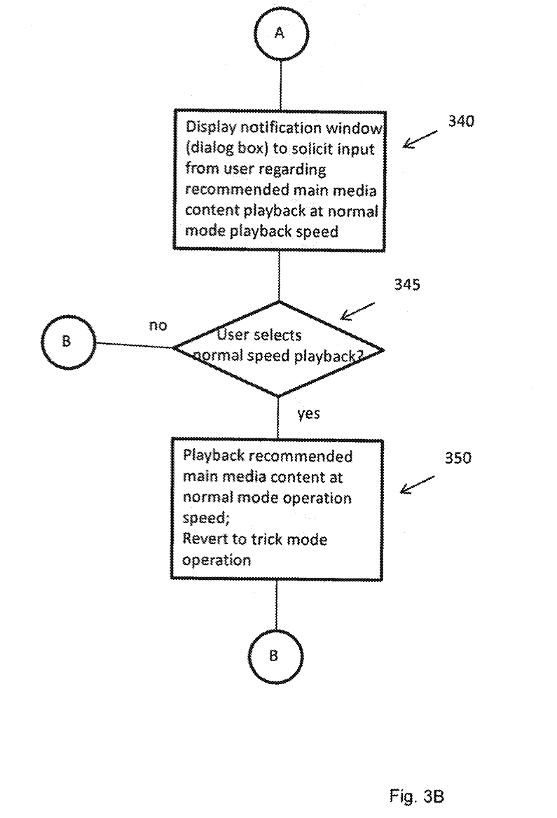

The media player may be implemented in software, hardware, or any combination thereof. For example, the media player may be a set-top-box (STB) for playing digital television content, a Digital Video Recorder (DVR) for playing previously recorded video content. Other types of media players may include Digital Versatile Disc (DVD) player, portable MP4 players, Windows media players by Microsoft and QuickTime players by Apple installed on personal computers or mobile devices including but not limited to laptops, personal digital assistants (PDAs), mobile phones, dual mode smart phones, and iPAD type devices. In general, the media player function is divided into normal playback operations such as “Play”“Stop” “Pause” and trick mode playback operations such as “Fast Forward” or “Rewind”. An end user may switch between these two modes of operation at any time and at any point in media content playback. The method of the present invention interrupts trick mode operation (trick mode intervention) with the additional content description (metadata) to prompt an end user to select whether the end user wants to continue in trick mode and inadvertently miss an important (key) segment of the media content. The normal playback mode portion of the media player accepts (receives, retrieves, reads) multimedia (main) media content. The trick mode playback portion of the media player accepts (receives, reads) additional content (metadata). The additional content (metadata) is indicated by a dotted arrow because this additional content (metadata) will not be forwarded or accepted if the media player is not in trick play mode of operation. It would be unnecessary and superfluous. The player control portion of the media player accepts (receives, reads) data indicating the indices of the recommended metadata. The player control portion of the media player controls both the trick mode playback portion and the normal mode playback portion of the media player taking the media player in and out of trick mode and normal modes of operation in accordance with the method shown in FIG. 3 and shown on the exemplary timeline of FIG. 2. The trick mode playback component displays the recommended metadata on an auxiliary display device of the media player. The trick mode playback component displays the multimedia content on a main display device of the media player at a trick mode playback speed.

FIG. 2 is an exemplary multimedia playback sequence for media content and additional content (metadata) during “Fast Forward” trick mode operation in accordance with principles of the present invention. The star icons on the playback timeline show the start point of the trick mode. Starting at the left, the first trick mode intervention occurs outside (before, prior to) the starting position of recommended (main) media content (R₁^{s}). Therefore, at time R₁^{s}−D₁, the additional content (metadata) will be displayed to provide more information from the content director or content source creator. D₁ is the duration of the first additional content (metadata). One example of additional content (metadata) may be the description of the director to place a 360 degree view of an explosion to highlight the action's effect or to highlight the special effects of the explosion. Another example of additional content may be the comments from a previous audience that this part of the content is very touching with beautiful scenery and background music. After the playback of the additional content, if the end user accepts to view the recommended portion of the main media content that was suggested to be key (important), then playback will revert to normal playback mode to fulfill the playback from R₁^{s} to R₁^{e} in the playback timeline as shown in FIG. 2. Moving to the right along the timeline, the second trick mode intervention occurs inside the recommended segment (after the recommended segment would have to have been started to view the entire recommended segment). In this case, there will be no waiting time left, the additional content (metadata) will be played immediately, and if the end user accepts the suggestion to view the media (main) content at normal playback speed, then media content playback will revert to normal playback mode to fulfill the playing from R2^{s} to R₂^{e} on the playback timeline. In both examples, after the playing the recommended segment at normal playback speed, the playback mode will revert back to trick mode again.

Referring back to FIG. 1, the device display portions are the displays on which the media content is displayed. The main display device displays the main media content during normal playback mode. The auxiliary display device accepts (receives, reads) additional content (metadata) from the trick mode playback portion of the media player in order to ascertain if the end user wants to view the recommended segment in normal playback mode. The main display device may also accept (receive, read) additional content (metadata) from the trick mode playback portion of the media player in order to ascertain if the end user wants to view the recommended segment in normal playback mode. That is, either the main display device or the auxiliary display device may display the additional content (metadata).

The trick play mode intervention method of the present invention can be divided into the five main steps listed below. It is assumed that the media player is started in normal playback mode.
Step 1: During the media playing in normal speed, retrieve the recommended metadata (metadata associated with the main media content segment recommended for viewing), which may be in tabular form such as Table 1 or any other convenient format or any format compliant with the appropriate content standards. Parse the corresponding time and additional content (metadata) information, for example, the items (data in fields) illustrated in Table 1. The key function in this step is to identify the recommended segments (scenes, fragments, frames, sub-segments) that should be emphasized (that are key or important). Such information can be stored in a buffer assigned to the media player.
Step 2: Detect if the end user has initiated trick mode playback operation. For a software-implemented media player, a mouse click of “Fast Forward” or “Rewind” or predefined keyboard shortcuts can be considered as a trigger for initiation of trick mode operation. For a hardware-implemented media player, the detection of trick mode can be defined as the user pressing an appropriate key on the remote control or menu board or a button on the media player itself
Step 3: After the trick mode operation detection, the starting point of trick mode operation will be recorded and compared with the next recommended main media content. If the next recommended main media content segment is outside of (prior to, before) the recommended main media content segment, then the play-out time for the additional content will be calculated and the additional content (metadata) will be played at the corresponding start time. The play-out time is the duration of the playing out of the unit of content. If the starting point of trick mode playback is located inside the latest recommended main media content segment, then the additional media content (metadata) will be played immediately to emphasize that some key frames or segments will be missing if trick mode playback is continued.
Step 4: After the playing of additional content (metadata), a notification window (dialog box) will be displayed to solicit input from the end user as to whether or not to see the recommended main media content segment in normal playback mode (at normal playback speed). In one embodiment the dialog box is a message box including a message similar to “Do you want to view the recommended segment at normal playback speed?” with “radio buttons” for “Yes” and “No” and a checkbox “Use the same choice next time?”. In one embodiment, if the end user selects “Yes” and checks the box then the next time, the recommended main media content will be played immediately. If the end user selected “No” and checked the box, then the recommended main media content will not be played and the trick mode will be operated without further intervention. In an alternative embodiment, if the end user selects “Yes” and checks the box then the next time, the recommended main media content will be played immediately with no further display of metadata (additional content) for the next recommended main media content. In another scenario, if the end user selects “Yes” and does not check the box then the next time, the additional content (metadata) will be played and the message (dialog) box will again be displayed. It can be assumed that the dialog box along with the additional content (metadata) is displayed at normal playback speed and not at trick mode speed.
Step 5: After the playing of recommended main media content at normal speed, the media player will revert to trick mode playback operation until the end user terminates this function or another recommended main media content segment occurs during trick mode operation.

FIGS. 3A and 3B together are a flowchart of the operation an embodiment of the trick mode intervention system of the present invention. Referring first to FIG. 3A it is assumed that upon power on the media player starts playing selected media content (may be, for example a compact disc (CD) or digital video disc (DVD)) at normal mode speed. At 305, the media player performs a test to determine if the media content playback (at any speed) is complete. If the media content playback, the method (process) ends for this media content. If the media content playback is not complete, at 310, the media player accepts (receives, retrieves) the recommended metadata (metadata associated with the main media content segment recommended for viewing), which may be in tabular form such as Table 1 or any other convenient format or any format compliant with the appropriate content standards. The media player parses the corresponding time and additional content (metadata) information, for example, the items (data in fields) illustrated in Table 1. The key function in this step is to identify the recommended segments (scenes, fragments, frames, sub-segments) that should be emphasized (that are key or important). Such information can be stored in a buffer assigned to the media player. At 315, a test is performed to determine if trick mode operation initiation has been detected. If trick mode operation has not been detected, then processing proceeds to 305. If trick mode operation has been detected then, at 320, the starting point of trick mode operation in the main media content will be recorded. At 325, a test is performed to determine if the next recommended main media content segment is outside of (prior to, before) the recommended main media content segment. If the next recommended main media content segment is outside of (prior to, before) the recommended main media content segment, then at 330, the play-out time for the additional content will be calculated and a corresponding start time to start play-out of the additional content (metadata). The play-out time is the duration of the playing out of the unit of content. The additional content (metadata) will be played out (back) at the corresponding start time. If the starting point of trick mode playback is located inside the latest recommended main media content segment, then at 335, the additional media content (metadata) will be played immediately to emphasize that some key frames or segments will be missing if trick mode playback is continued.

Referring now to FIG. 3B, at 340, a notification window (dialog box) will be displayed to solicit input from the end user as to whether or not to see (view, play, hear) the recommended main media content segment in normal playback mode (at normal playback speed). In one embodiment the dialog box is a message box including a message similar to “Do you want to view the recommended segment at normal playback speed?” with “radio buttons” for “Yes” and “No” and a checkbox “Use the same choice next time?”. FIG. 3B does not show the test and logic for the second question. A test is performed at 345, to assess the end user's input. At 350 if the end user selects “Yes” and checks the box then the next time, the recommended main media content will be played immediately. If the end user selected “No” and checked the box, then the recommended main media content will not be played and the trick mode will be operated without further intervention. In an alternative embodiment, if the end user selects “Yes” and checks the box then the next time, the recommended main media content will be played immediately with no further display of metadata (additional content) for the next recommended main media content. In another scenario, if the end user selects “Yes” and does not check the box then the next time, the additional content (metadata) will be played and the message (dialog) box will again be displayed. It can be assumed that the dialog box along with the additional content (metadata) is displayed at normal playback speed and not at trick mode speed.

The present invention is practiced in a media player (shown in FIG. 1) having three main components—a normal mode playback component, a trick mode playback component and a player control component. The trick mode playback component accepts metadata and displays the metadata (metadata associated with the main media content segment recommended for viewing) on an auxiliary device of the media player. The trick mode playback component also displays the multimedia content on a main display of the media player at a trick mode playback speed. The normal mode playback component includes means for accepting multimedia content and means for playing back of one of the stored identified segments of multimedia content at a normal mode speed responsive to the accepted input. The means for accepting and means for playing back are preferably performed by a processor executing associated instructions stored in memory. The means for accepting and means for playing back may be executed by a single processor or by two or more processors. In the alternative, the means for accepting and means for playing back may be implemented in hardware or firmware including implementations using application specific integrated computers (ASICs) an/or field programmable gate arrays (FPGAs) or special purpose processors or any combination thereof, for example. The player control component controls the normal mode playback component and the trick mode playback component of the media player. The player control component also accepts an index of metadata. The player control component also includes means for identifying segments of multimedia content that are recommended for viewing. means for storing the identified segments of multimedia content, means for detecting trick mode playback initiation, means for determining if a starting point of the trick mode playback is prior to a next identified segment, means for determining a play-out time for the metadata if the first determination is positive, means for determining a corresponding time to start play-out of the metadata, means for playing back the metadata starting immediately if the first determination is negative or at the determined corresponding time (this is accomplished by initiating normal mode playback based on the determination with display being on the main display device of associated with the media player), means for displaying a dialog box with a query (this is accomplished at normal mode speed by controlling the normal mode playback component with the display being on the main display device associated with the media player), means for accepting input from a user in response to the query, means for reverting to trick mode playback upon completion of the playing back of the one of the stored identified segment of multimedia content (this is accomplished by initiating trick mode playback in the trick mode playback component by the player control component). Each of the means for of the player control components are preferably performed by a processor executing associated instructions stored in memory. The various means for may be executed by a single processor or by a plurality of processors. In the alternative, the means for accepting and means for playing back may be implemented in hardware or firmware including implementations using application specific integrated computers (ASICs) an/or field programmable gate arrays (FPGAs) or special purpose processors or any combination thereof, for example.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method, said method comprising:
accepting metadata;
identifying segments of multimedia content that are recommended for viewing;
storing said identified segments of multimedia content;
detecting trick mode playback initiation;
determining if a starting point of said trick mode playback is prior to a next identified segment;
determining a play-out time for said metadata if said first determination is positive;
determining a corresponding time to start play-out of said metadata;
playing back said metadata starting immediately if said first determination is negative or at said determined corresponding time;
displaying a dialog box with a query;
accepting input from a user in response to said query;
playing back of one of said stored identified segments of multimedia content responsive to said accepted input at a normal mode speed; and
reverting to trick mode playback upon completion of said playing back of said one of said stored identified segment of multimedia content.

2. The method according to claim 1, wherein said identifying step further comprises parsing said metadata.

3. The method according to claim 1 further comprising determining if playing of all segments of said multimedia content has been completed.

4. An apparatus, comprising:
means for accepting metadata;
means for identifying segments of multimedia content that are recommended for viewing;
means for storing said identified segments of multimedia content;
means for detecting trick mode playback initiation;
means for determining if a starting point of said trick mode playback is prior to a next identified segment;
means for determining a play-out time for said metadata if said first determination is positive;
means for determining a corresponding time to start play-out of said metadata;
means for playing back said metadata starting immediately if said first determination is negative or at said determined corresponding time;
means for displaying a dialog box with a query;
means for accepting input from a user in response to said query;
means for playing back of one of said stored identified segments of multimedia content at a normal mode speed responsive to said accepted input; and
means for reverting to trick mode playback upon completion of said playing back of said one of said stored identified segment of multimedia content.

5. The apparatus according to claim 4, wherein said identifying means further comprises means for parsing said metadata.

6. The apparatus according to claim 4 further comprising means for determining if playing of all segments of said multimedia content has been completed.

7. The apparatus according to claim 4, wherein said apparatus is a media player.

8. The apparatus according to claim 4, wherein said apparatus comprises a normal mode playback component, a trick mode playback component and a player control component.

9. The apparatus according to claim 8, wherein said normal mode playback component accepts said multimedia content.

10. The apparatus according to claim 8, wherein said trick mode playback component accepts said metadata.

11. The apparatus according to claim 8, wherein player control component accepts an index of metadata.

12. The apparatus according to claim 8, wherein player control component controls said normal mode playback component and said trick mode playback component.

13. The apparatus according to claim 8, wherein said trick mode playback component displays said metadata on an auxiliary display device of said media player.

14. The apparatus according to claim 8, wherein said trick mode playback component displays said multimedia content on a main display device of said media player at a trick mode playback speed.
